(19) United States
(12) Patent Application Publication
(10) Pub. No.: US 2007/0157086 A1
(43) Pub. Date: Jul. 5, 2007

(54) Time-Controlled Presentation of Content to a Viewer

(76) Inventor: Leonard L. Drey, St. Louis, MO (US)

Correspondence Address: IP STRATEGIES, 12 1/2 WALL STREET, SUITE I, ASHEVILLE, NC, 28801, US

(21) Appl. No.: 11/620,512

(22) Filed: Jan. 5, 2007

Related U.S. Application Data
(60) Provisional application No. 60/756,467, filed on Jan. 5, 2006.
(60) Provisional application No. 60/758,447, filed on Jan. 12, 2006.

(51) Int. Cl. G06F 17/00

(52) U.S. Cl. 715/531; 715/530; 715/513

(57) ABSTRACT

A method of displaying a document on an electronic display device includes creating a document file, delimiting at least a predetermined portion of the text of the document file, to define delimited content, and displaying the document file such that the delimited content is displayed differently with respect to timing than other portions of the content of the document file.

### CROSS-REFERENCE TO RELATED APPLICATIONS

This is related to, and claims the benefit under 35 USC §119(e) of U.S. Provisional Application for Patent No. 60/756,467, which was filed on Jan. 5, 2006, and U.S. Provisional Application for Patent No. 60/758,447, which was filed on Jan. 12, 2006.

### FIELD OF THE INVENTION

The invention relates to methods of presenting content to a viewer, for example, on an electronic display device. In particular, the invention relates to control over the timing of the presentation of the content.

### BACKGROUND OF THE INVENTION

Content, and text in particular, is usually presented in static fashion. That is, when a reader reads text and other content in hard-copy form, text and images do not change, and subtle nuances in the meaning of what is conveyed in the content must be expressed through the careful use of words and static images. Content provided to a viewer on a computer has the potential to overcome this constraint, but this capability is underutilized. A need exists to more fully utilize the capability of electronic media, so that dynamic content can be provided that transcends static limitations of expression.

### BRIEF SUMMARY OF THE INVENTION

One aspect of the invention is a method of displaying a document on a electronic display device. According to this aspect of the invention, a document file is created. The document file is a computer-readable file that includes content, and the content includes text. At least a predetermined portion of the text of the document file is delimited, to define delimited content. The document file is displayed such that the delimited content is displayed differently with respect to timing than other portions of the content of the document file.

Preferably, the document file is created without writing programming code, other than the possible addition of HTML tags. It is also preferred that delimiting at least a predetermined portion of the text of the document file does not include writing programming code.

The document file can include one or more of text; links to still image files, moving image files, sound files, and binary files; formatting tags, forms, and hyperlinks to Web pages, and the content can include one or more of text, still images, moving images, sounds, and Web pages. Accordingly, the delimited content can include one or more of text, symbols, numbers, geometric shapes, still images, moving images, and sounds. For example, the delimited content can include delimited text, and the delimited text can include one or more of pages of text, paragraphs of text, sentences, words, characters, and groups of characters.

The document file can be one of a plaintext file, an HTML file and an XHTML file.

The document file can include at least one string. For example, the document file can include a sequence of strings. The strings are not necessarily related; one string in the sequence can be different than other strings, and one string can be the same as another string.

Delimiting at least the predetermined portion of the text of the document file can included adding at least one delimiter to the text of the document file such that the at least one delimiter is associated with the predetermined portion of the content of the document file, to define the delimited content. Preferably, at least two different delimiters are used. A microprocessor device can read the document file with at least one delimiter and cause the document to be displayed on the electronic device.

The content can also includes at least one object tag, where “object” refers to any identifiable portion or aspect of the content. For example, the object tag can include one or more of the following: formatting tags, hyperlink tags, image source tags, sound source tags, video source tags, table tags, form tags, frame tags, style tags, div tags, class tags, embed tags, object elements, JavaScript, and Java applets.

Displaying the document file can include using a computer operating program to run the document file. For example, the computer operating program can be a JavaScript program. The document file and the operating program can be combined, or each can be freestanding.

Displaying the document file can include reading the document using a network interface. For example, the network interface can be a Web browser. The method of the invention can also include storing the document file and an operating program, for access by a hyperlink, and displaying the document file can include selecting the hyperlink.

Delimiting portions of the document might require action by a viewer in order for the complete document to be displayed. For example, the at least one delimiter can include a delimiter that allows at least one portion of the content to be displayed, and prevents the delimited content from being displayed automatically. The delimiter can allow the delimited content to be displayed only after a viewer performs a predetermined function. For example, the predetermined function can be movement of an action key, such as an element of an input device in communication with a microprocessor device that is in communication with the electronic display device. The action key can be, for example, an enter key, which is moved by depressing the key.

The timed presentation of content can be made automatic. For example, the at least one delimiter can include a delimiter that allows at least one portion of the content to be displayed before a predetermined delay, and the delimited content to be displayed automatically after the predetermined delay. The delimiter can be numerically specified to predetermine the amount of the delay.

The format of the content can be changed automatically over time as well. For example, the at least one delimiter can include a delimiter that allows the delimited content to be displayed in a first format before a predetermined delay, and in a second format after the predetermined delay. As an example, the delimited content can include delimited text, and the first format and the second format can respectively include any one or more of underlining, italicizing, bolding, coloring, highlighting, font changing, size changing, striking through, superscripting, subscripting, shadowing, outlining, embossing, engraving, capitalizing, converting to a hyperlink, hiding, spacing, and blinking applied to the delimited text. Again, the delimiter can be numerically specified to predetermine the amount of the delay.

The format change of the content can also depend on viewer intervention. For example, the at least one delimiter can include a delimiter that allows the delimited content to be displayed in a first format before a viewer moves an action key, and in a second format after the viewer moves the action key. As noted above, the action key can be an element of an input device in communication with a microprocessor device that in communication with the electronic display device, such as an enter key. The delimited content can include delimited text, in which case the first format and the second format can respectively include any one or more of underlining, italicizing, bolding, coloring, highlighting, font changing, size changing, striking through, superscripting, subscripting, shadowing, outlining, embossing, engraving, capitalizing, converting to a hyperlink, hiding, spacing, and blinking applied to the delimited text.

The delimiters can also be used to replace the displayed content automatically. For example, the at least one delimiter can includes a delimiter that allows the delimited content to be displayed before a predetermined delay and replacement content to be displayed automatically after the predetermined delay. According to this example, the document file can include a sequence of strings, and advancing through the sequence of strings can cause the delimited content to be displayed before the predetermined delay and the replacement content to be displayed automatically after the predetermined delay. The delimiters can be specified to predetermine the amount of the delay.

The delimiters can also be used to replace the displayed content after action by a viewer. For example, the at least one delimiter can include a delimiter that allows the delimited content to be displayed before a viewer moves an action key, and replacement content to be displayed after the viewer moves the action key. The action key can be an element of an input device in communication with a microprocessor device that in communication with the electronic display device, such as an enter key. According to this example, the document file can include a sequence of strings. Movement of the action key can cause advancement through the sequence of strings.

This replacement action can affect an entire screen of text, or a portion of a screen of text. For example, the electronic device can include a display screen that has a viewing area, and the delimited content can fill the viewing area. The replacement content can then replace all of the delimited content in the viewing area. The content filling the viewing area can then be replaced with new replacement content by successive movement of the action key. If the content is framed content, the viewing area can be at least one frame of the framed content.

Additional content can also be added and changed through the use of the delimiters. For example, the delimited content can be additional content, which can be displayed concurrently with other portions of the content. Therefore, if the electronic device includes a display screen, the additional content can be displayed on the display screen concurrently with the other portions of the content. The additional content can include, for example, additional text, which can include one or more of letters, symbols, spaces, numbers, words, sentences, paragraphs, characters, and groups of characters. The additional content can include, for example, annotation content. The at least one delimiter can include a delimiter that prevents the additional content, such as annotation content, from being displayed before a predetermined delay and allows the annotation content to be displayed automatically after the predetermined delay, and the delimiter can be numerically specified to predetermine the amount of the delay. The at least one delimiter can include a delimiter that prevents the additional content, such as annotation content, from being displayed before a viewer moves an action key, and allows the additional content to be displayed after the viewer moves the action key. The opposite action can also be specified. That is, additional content, including annotation content can be allowed to be displayed before a delay or viewer action, and can be prevented from being displayed after a delay or viewer action. The action key can be an element of an input device in communication with a microprocessor device that is in communication with the electronic display device, such as an enter key.

According to another aspect of the invention, a storage medium includes operating instructions that can be implemented by a microprocessor device to cause a document to be displayed on an electronic device. The instructions include allowing an author to create a document file, allowing the author to delimit at least a portion of the text of the document file, to define delimited content, and displaying the document file such that the delimited content is displayed differently with respect to timing than other portions of the content of the document file. The document file is a computer-readable file that includes content, and the content includes text.

The instructions can also include an operating program. The document file can be embedded in the operating program.

Allowing the author to delimit at least a portion of the text of the document file can include allowing the author to add delimiting text. Allowing a author to create a document file can include allowing a author to create a document file according to a standard application program, that is, a program that can be used without applying computer programming skills or writing code, such as a word processing program.

According to another aspect of the invention, an integrated device includes the storage medium described above, as well as a microprocessor device and an electronic display device. Displaying the document file such that the delimited content is displayed differently than other portions of the content of the document file can includes allowing at least one portion of the content to be displayed, and preventing the delimited content from being displayed automatically. Displaying the document file such that the delimited content is displayed differently than other portions of the content of the document file can also include allowing the delimited content to be displayed only after a viewer performs a predetermined function. For example, the integrated device can also include an action key in communication with the microprocessor device, the predetermined function can be movement of the action key.

### BRIEF DESCRIPTION OF THE DRAWINGS

FIG. 1 is a flow diagram that shows an exemplary general process of the invention.

FIG. 2 is a flow diagram that shows a particular exemplary aspect of the authoring and display processes of the invention.

FIG. 3 is a flow diagram that shows a particular exemplary aspect of the authoring and display processes of the invention.

FIG. 4 is a flow diagram that shows a particular exemplary aspect of the authoring and display processes of the invention.

FIG. 5 is a flow diagram that shows a particular exemplary aspect of the authoring and display processes of the invention.

FIG. 6 is a flow diagram that shows a particular exemplary aspect of the authoring process of the invention.

FIG. 7 is a block diagram of an exemplary integrated device according to the invention.

FIG. 8 is a flow diagram of an exemplary program implementing the invention.

### DETAILED DESCRIPTION OF THE INVENTION

The present invention provides a way for presenting text characters and other content to a viewer, such as a computer user, in predetermined groups, which can be temporally sequenced, according to the depression of one or more predetermined control or action keys or automatically as specified by the author of the content that is being viewed. For example, according to the invention, words, letters, numerals, symbols, blocks of color, digital photographs, graphical images, movies, sound, any other visual and/or audio binary file, forms or interactive forms, and Web pages can be presented on a viewer's display one at a time, or according to any other grouping intended by the author, either in an automatic timed sequence or as controlled by the reader using the action key. A single action key will be referred to herein, but the invention is not contemplated necessarily to be limited to a single action key, and more than one key can be designated as action keys if desired.

Thus, according to a particular embodiment of the invention, series of these groupings can be presented sequentially to the viewer, wherein the sequencing of the groupings is predetermined by the author at the time of authoring the text, and the viewing of the sequence can be controlled by the viewer according to the depression of the action key. For example, certain intermittent interruptions of presentation of the text caused by the authoring process can be ended by the viewer's pressing an action key, such as the Enter key, which will be used herein as a non-limiting example of an action key that can be used according to the method of the invention. Other features, such as pauses in the presentation of the text for any length of time in increments of, for example, tenths of seconds, can be authored into the text so as to affect the viewer's interpretation of what is written in ways that static text cannot provide.

To implement the method of the invention, text is written by an author/programmer so as to be read by a reader's computer, or other microprocessor device, as computer code. This code can be, for example, similar to or no different than ordinary HTML code, but provides several advantages. The code includes delimiters that the author can use when writing/coding that will halt or pause presentation of text to the viewer at whichever point(s) the author chooses. These delimiters can be combined. Thus, for example, words or any grouping of text can be presented a letter at a time, or a paragraph can be hidden for a moment before the reader can see it. Alternatively, the paragraph's presentation can be withheld entirely until the action key is depressed.

In a preferred embodiment, the text or other content is authored such that text, or the ordinary language of HTML or XHTML or another compatible language for the Web, is augmented with new time-specific delimiters. The text is coded by the author in “strings” that include the delimiters. For example, a string can begin with
LABEL(“. . .
   and end with
. . . )”;
   to identify delimited text, where “LABEL” is a label chosen by the author to designate the delimiter. A first delimiter allows the author to halt the presentation of text on a reader's display until an action key has been struck by the reader, while another delimiter allows the author to pause the presentation of text for a predetermined duration, irrespective of any action by the reader. Although two such delimiters are described herein, additional or different delimiters can be used to provide similar or different time functions, as will be apparent to one of skill in the art. According to the method of the invention, all formatting features of HTML can be used. Retaining the broad feature set capability of HTML provides great advantages to the author.

The sequential presentation of text can also be used to change the format of the text that the reader is reading. For example, the author can author two successive strings of text that vary only in a particular detail, such as encoding for the color of a word, or bolding or underlining of text for emphasis. When the reader strikes the action key, all he will see is the change in the selected word, while the rest of the text appears to remain the same.

Annotations can also be made to appear and go away at the stroke of the action key. For example, these notes can appear in indented and highlighted boxes, or in any other format of the author's choosing. Highlighting or other emphasis of text can also come and go, timed to change automatically according to the author's specification or on depression of the action key by the viewer.

HTML documents can be made to appear as “pages” that appear on the viewer's screen, one by one, in a timed sequence or at the control of the viewer. For pages to appear in an automatic timed sequence, at the end of each string that makes up a page or one of a set of pages, a delay delimiter can be inserted. For example,
LABEL(“ . . . ˆˆ25ˆ”);
   or a similar delimiter is inserted, where “ˆ” All is a space, and where “space-space-number-space” is the incremental delay delimiter denoting the number of incremental delay units, here measured in tenths of a second. Likewise, “space-space-vertical pipe-space” (ˆˆ|ˆ) can be used as the “stop until the action key is depressed” delimiter, so that pages can change at the control of the viewer. An “automatic blank screen” string, for example,
LABEL(“<ul><br>ˆˆ0.5ˆ<br><br>”);
   can be made to occur between ordinary text strings, to generate a momentarily blank screen between screens of text.

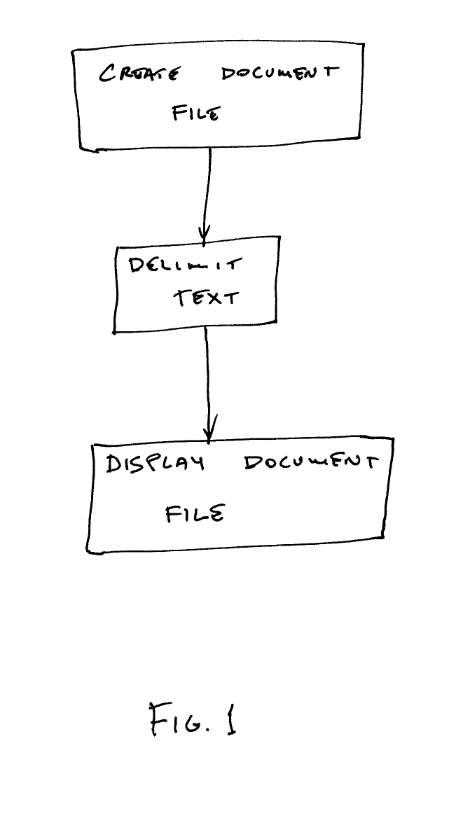

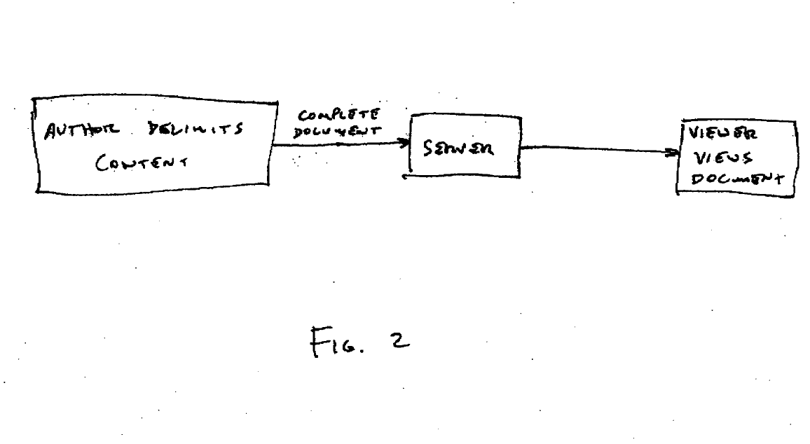

An exemplary general process of the invention is shown in FIG. 1. As shown, the author creates a document file by authoring content that preferably includes text. Predetermined portions of the text are delimited in order to define delimited content. The document file is then displayed to a viewer, and the delimited content is displayed differently than other portions of the content of the document file. As previously described, the difference in presentation to the viewer of the delimited content is in the timing of the presentation. The timing differences can be automatic, or controlled by the viewer as specified by the author. The coding of the delimiters can be made transparent to the author, so that computer programming skills are not needed. For example, a word processing program can have delimiting functions added as a feature that is selectable from a menu, so that designated characters can be specified for timed presentation according to the invention. Regardless, delimiters will “drop out,” in the sense that although they will have meaning to the microprocessor running the operating program, the viewer will never see them on his or her screen, even as a space.

The document file need not only include text, and instead can be a multimedia file including still and moving images and sound as content, any instance of which can be delimited. Further, HTML files and XHTML files can be document files that are authored according to the invention, and any specified content in such a document can be delimited for timed presentation to a viewer.

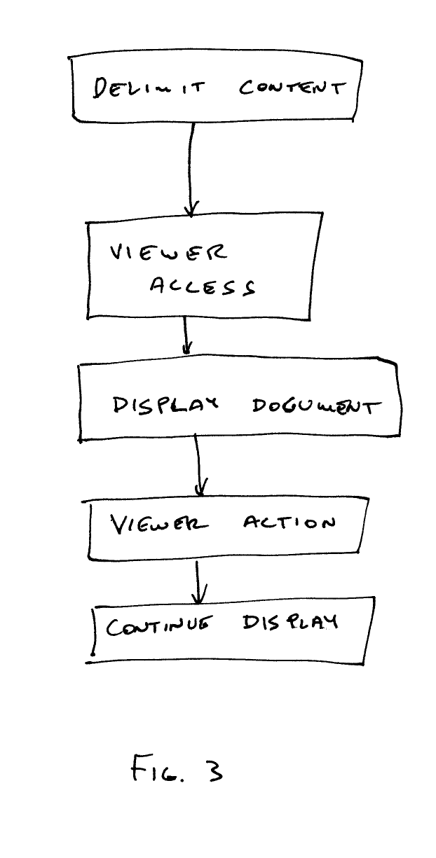

As shown in FIG. 2, as part of the authoring process, the author defines delimited content in the document file, as the document file is first authored, or later, in a separate delimiting action. The viewer will display the document on a microprocessor device such as a computer or dedicated document reader, which will identify the delimited content and present it to the viewer as specified by the author. If the computer or other viewing device is connected to a network, the document file can be stored on a server or in a location at which it can be accessed by a server, and a network interface program can be used to view the document file. For example, a Web browser running on a notebook computer with a wireless Internet connection can be used to view the document file, and the document file can be accessed via inserting the Web address of the combined document (document file embedded in operating program) in a browser task bar.

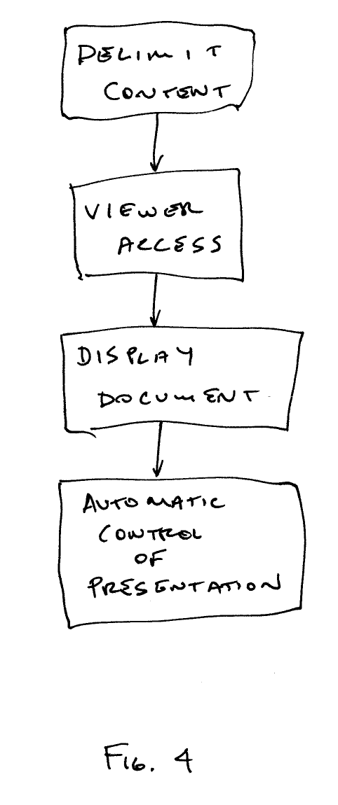

As shown in FIG. 3, the authoring process can include delimiting the content such that further action is required by the viewer to view the document file completely. As previously discussed, this can include the use of an action key. The viewer will be able to display a portion of the document file, but subsequent viewing of delimited content will require additional action as specified by the author.

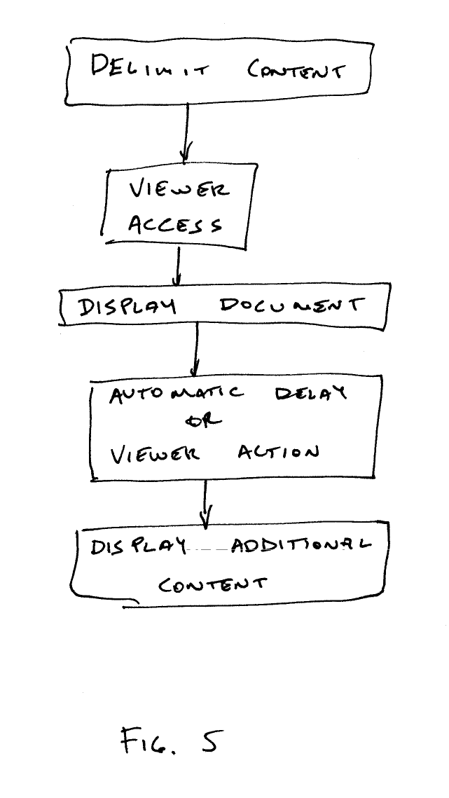

As shown in FIG. 4, the authoring process can include delimiting the content such no further action is required by the viewer to view the document file completely, but the presentation of portions of the document file can be timed as specified by the author. The viewer will be able to display a portion of the document file right away, but subsequent viewing of delimited content will require the viewer to wait. Of course, through the use of both types of delimiters by the author, the timed presentation of the document file to the viewer can be a result of a combination of required action by the viewer, then waiting by the viewer.

As discussed previously, the timed presentation of the content to the viewer can include format changes to the content, such as presenting text in a first format and than in a second format, either automatically or after viewer action. These and other content changes can be effectuated through the use of sequence strings to replace displayed content with replacement content. If the content is authored as a sequence of strings, advancing through the sequence, either automatically or after viewer action, can cause the replacement of content as each new string is read.

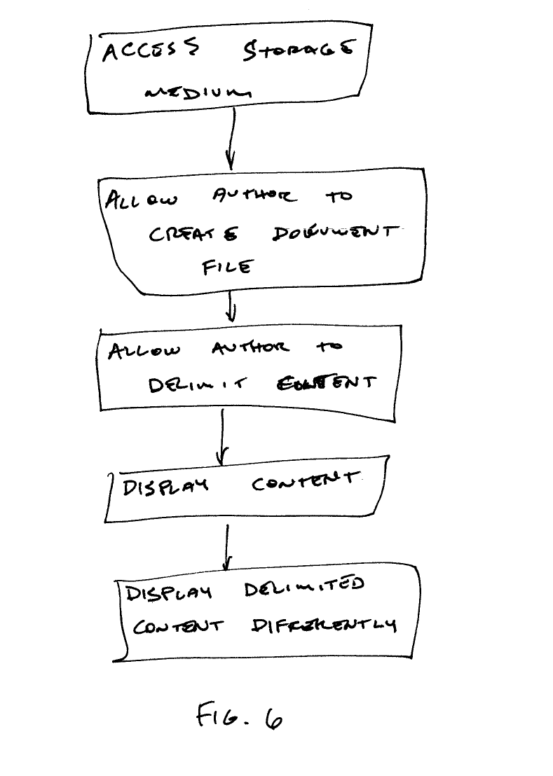

As shown in FIG. 5, the authoring process can include delimiting content that will be added after a delay or after viewer action, and which can be changed after further delay or viewer action. This additional content is displayed concurrently with other portions of the content, which also can be changed over time. For example, annotation content can be added after a viewer has read the originally-presented content, which can then be changed after the viewer has read the annotations.

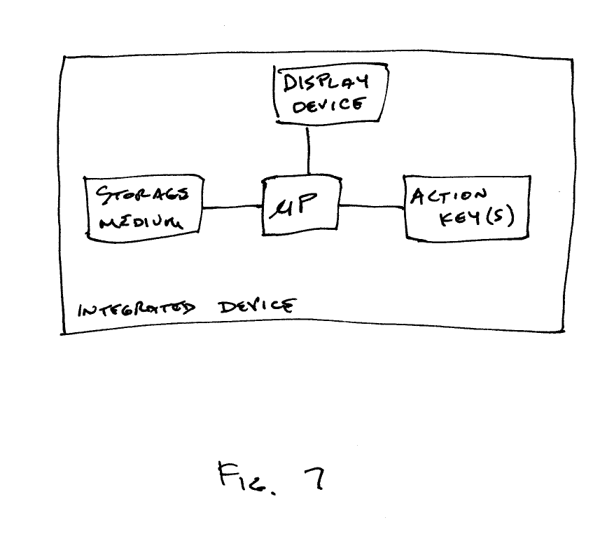

Thus, the authoring process includes delimiting the content of a document so that the timed presentation of the document is controlled, either automatically or by the viewer, or both. The capability to author a document in this manner can be provided by programming instructions stored on a medium, such as a portable memory device or a hard drive internal to a computer, or by instructions resident temporarily in RAM. The stored instructions can be implemented by a microprocessor device to cause a document to be displayed on an electronic device by allowing an author to create a document file as described above, as shown in more detail in FIG. 6. The resulting document file is a computer-readable file that includes the content, both delimited and non-delimited, as described above. The document file can be one that is authored on a standard application program, such as a word processing program.

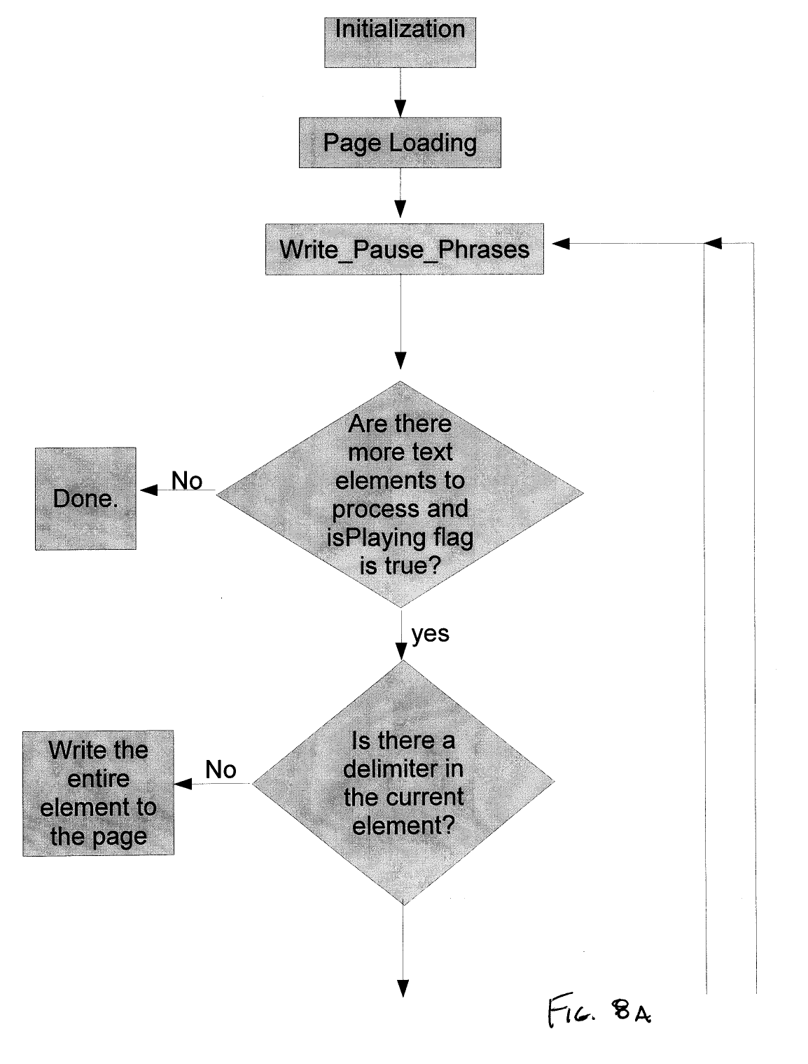

It is also contemplated that the invention can be embodied as an integrated device that includes the storage medium described above, as well as a microprocessor device and an electronic display device, as shown in FIG. 7. The integrated device can include an action key in communication with the microprocessor device for initiating viewer action.

Other embodiments of the invention can provide additional features. For example, hyperlinks can be used on a page in such a way as to cause a table of contents to appear after a number of pages have been viewed, so the process can resume in the hyperlinked document. Therefore, an ensuing document can be indefinitely long and will resemble a magazine, newspaper, or book, with any number of articles or chapters. “Chapter jump forward,” “chapter jump back,” and “jump screen behind” features, or other non-sequential access features, can also be provided through the use of one or more additional delimiters. Tables of contents can comprise simple hyperlinked lists, or they can be geometrically more complex shapes, including graphics, digital photographs, and text, created, for example, using HTML's “table” or “DIV” functions, preferably hyperlinked. “Advertisement blocks,” possibly hyperlinked to Web pages or to stand-alone documents authored according to the invention, can also appear on table of contents pages, or anywhere else in the document.

Thus, depending on how the delimiters are used when the document is authored, pages can turn automatically for the reader, with words appearing on, remaining on, and disappearing from the display before the page turns again. Through the thoughtful use of delimiters, any size object of text can be designated for such timed presentation, where “object” herein is meant to mean any desired subset of content. For example, poetry can be advantageously displayed as the author prefers that the reader should see it. Words or even portions of words or individual letters, phrases, lines, and stanzas can appear automatically after a suitable delay, giving the reader enough time to read that passage but also allowing the author to provide emphasis by varying the delay for different passages. Alternatively, passages can be presented to the reader one at a time as fixed screens that sequence as the reader depresses the action key. In the same manner, blocks of color, formatted text, digital photographs, graphics, sound, and so forth, can be used to present a form of artwork to the reader, in a way that appears as a slideshow or even as animation.

Two different exemplary implementations of the method are described below, one simple and the other more complex. In the simpler version, the text of the document file will always run at full screen, with no specific accommodation made for the presentation of large files, including digital photographs, graphics, movies, or sound, for instance. Therefore, if an author using this implementation wants to present large files, the viewer will have to wait while these files download, unless the viewer chooses to advance the page without having seen them. In this simpler version of the invention, each document will comprise a single document file, within which the author's text is inserted appropriately as a series of strings. Therefore, both content and delimiters will be received as a single file on the reader's computer.

In a more complex implementation, once a document is selected by a viewer, as for example by hyperlinking from a table of contents, any large files associated with it, for example, digital photographs, graphics, sound files, and the like, will automatically and in sequence begin to download to the reader's computer. Thus, by the time the reader reaches the points where these large files would appear, they will more likely have downloaded onto his computer, to be fully available when they are requested. This provides great advantages for rendering digital photographs, graphics, sound, and the like, within the context of an article, but moreover it permits advertisements to be rendered in any position in an article, with little fanfare.

In the more complex implementation described above, a JavaScript file (with suffix, “.js”) including “operating sequences” according to the invention, will preferably be maintained separately on a central server, rather than being routinely downloaded onto the reader's computer every time a document is to be viewed, while individual textual, photographic, graphical, and similar files will preferably be downloaded each time a document is to be viewed. The individual textual, photographic, graphical, and similar files will be run using the operating program housed on the central server. This part of the method might involve the so-called “import” function of JavaScript. An advantage of this feature of the more complex implementation of the invention is that this “.js” file can be routinely hidden from viewers, so fees might have to be paid or a licensing agreement accepted, for them to see the code within the “.js” document. Furthermore, it might be expected that this “.js” file could be quite large, as in the simpler embodiment of the program it is not, and therefore it would be advantageous if this would not have to download each time that the viewer's computer needed to use it.

The more complex implementation will allow advertising to be presented because, for example, an initial “index.html” document can be a “frameset” document that will divide the screen into frames, some of which can include textual advertisements, which will in turn link to hyperlinked pages, which are sites stored on servers and available via the Internet or other network, or locally-stored textual documents written according to this method. In this case, “index.html” can open in such a way that the main frame will be “targeted” automatically so pages in this main frame automatically “turn” when the action key is depressed.

Alternatively, “index.html” can open at full frame without advertisements, and advertisements in side frames not be displayed until a “tableofcontents.html” document has been reached by the viewer through his or her pressing the action key an appropriate number of times.

In both cases, advertisements in the side frames can run sequentially, randomly, or according to some other automatic scheme, being delivered from a central server and changing after hyperlinks to articles, essays, and chapters that are listed in the table of contents have been selected by the viewer.

As another alternative, a document can be written according to this method without frames, with all documents presented in full frame.

The index.html, tableofcontents.html, and initial advertisement files can be very small (for example, on the order of 20 kB, together), since they can be textual, so they should download quickly regardless of the type of network connection. However, in the complex implementation, linked advertising files can be quite large and the reader still should not notice these files downloading, because at the time he will be reading the hyperlinked article. It is contemplated that the hyperlinks will be accessed via the Internet, via a private intranet, or over any network on which the linked server is available to provide the requested page.

Similarly, if the “table” or “DIV” methods of HTML are used to present advertisements rather than the “frames” method, so irregular “advertisement blocks” can appear on a table of contents page, which, likewise, might continuously change upon a reader's hyperlinking to an article, the advertisement blocks will not be confined to a frame or a gutter. In this exemplary embodiment, the advertisements initially present in these advertisement blocks will be purely textual documents, as this will enhance the speed of downloading once the reader opens the original “index.html” document.

Thus, according to the invention, the author of a document can control the manner in which it is displayed to a reader. Text can be timed to display and change automatically over time according to the author's specifications, or can be advanced only on the depression of one or more action keys, so that portions of the text can be rationed to the reader to suit the author's purpose.

The present invention includes the method as described above. Within the scope of the invention, the method can be implemented as a computer program, which can run on a computer or any device having a processor. The program can be loaded onto the computer directly, or can be implemented over the Internet or any other network. The invention can also be embodied as a storage medium on which is stored instructions that can be interpreted by a processor to cause a computer or other device to perform actions according to the described method, as described above.

The invention can also be embodied as a computer or other device on which the method is performed. For example, a general-purpose computer set up to author text as described herein, or set up on a network or as a stand-alone device and receiving documents authored according to the invention, are both contemplated as falling within the scope of the invention. Further, a special-purpose device dedicated to reading documents authored according to the invention is also contemplated. For example, a document file can be stored on a portable medium that can be read by such a special-purpose device, or document files can be downloaded onto the device via a network or directly from another computer or device. Such a special-purpose device will preferably be portable and will present documents to a viewer. Such a device can be functionally simple, including a display, a single action key, and a pointing device that can move a cursor to navigate the table of contents of a document being read. For example, a portable console having a suitable display can be provided with a touchpad pointing device and a single button, advantageously located for manipulation by a reader. The button can be used as the action key to move a document forward, and in combination with the touch pad can be used to navigate a table of contents. For example, a portable console having a suitable display can be provided on its rear surface with a touchpad pointing device and a single button, advantageously located for manipulation by the reader. Lateral movements made with the index finger of one hand on the touchpad device can be translated by the device into vertical movements through the table of contents.

It is also contemplated that more than one action key can be specified, or provided on a dedicated device. For example, the left-arrow key on a typical keyboard can be designated to be used by the viewer to drive the presentation backwards. For example, using this key, a bit of “automatic text” can be viewed more than once. Likewise, the right-arrow key on a typical keyboard can be designated to be used by the viewer to return the document to the point where the viewer had left off, regardless of how many times the left-arrow key and/or the Enter (action) key had been used in the intervening time.

Further, text or other content can be designated such that it is automatically brought to the top of the display on which the document is presented to the viewer, or at any other level. That is, the author controls the level at which a specified line of text will appear on a viewer's display. This allows, for example, highlighted text to be seen by the viewer without having search for it in a long column of text.

An additional feature can allow the viewer to interrupt the intended flow of the document. As stated previously, the invention permits any number of screens to unfold automatically on a viewer's display. There likely will be times when a viewer will want to skip over automatic text, as for example, when instructions have already been viewed. An additional key or combination of keys can be designated as the interrupt key or key sequence, by which the viewer can advance the program to the next static screen.

Thus, it is apparent that the invention provides a number of advantages. For example, when viewing a document authored according to the invention, a viewer can advance through a multi-page document effortlessly, without waiting for a link to download. Further, when strings are utilized in the authoring process, the viewer can see content such as text change colors or be highlighted, at the touch of a button, and text can easily be annotated. Text can be presented automatically, or this and a semi-automatic approach can be combined.

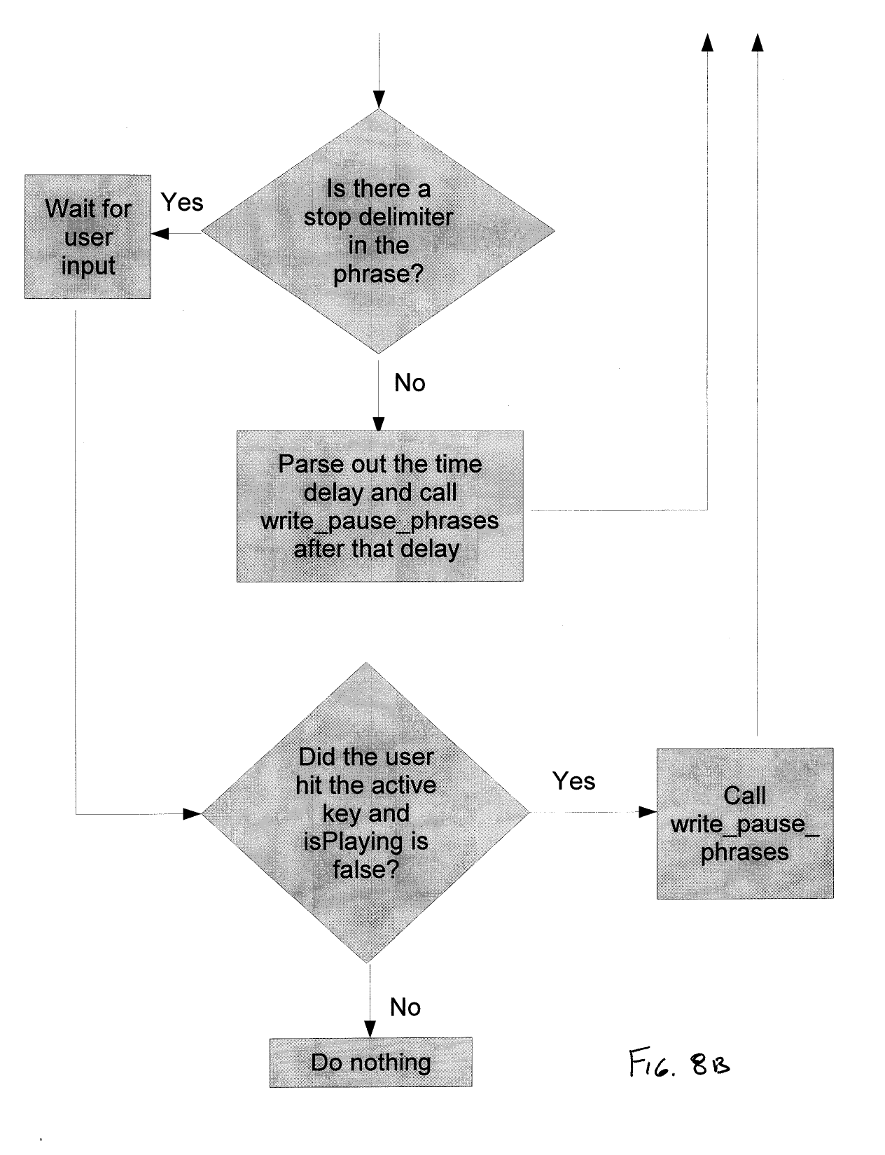

With reference to FIG. 8, an exemplary program description and flow of the invention is now described. This program processes text defined in an array of text elements. Each text element can be considered a “page” since it defines what will be visible on the viewer's display screen at any given time. Within each of these pages there can be a mix of text, HTML, halt delimiters, and pause delimiters with numbers representing time values. Each text element is processed depending on the delimiters and time values in it. Text elements without any delimiters will be shown all at once. Text elements with phrase delimiters will be processed a phrase at a time. Where there are stop delimiters, the processing will stop until the viewer depresses the appropriate “activeKey”. Where there are time values bounded by phrase delimiters, processing will be delayed by the specified time. While a given text element is being processed, the phrases will be written to the screen one after another. When processing of a text element is complete, page content is replaced by the content defined in the next text element. When the last text element has been processed, all processing will stop.

Global Variables—the Following Variables Are Referenced Throughout the Program

1. STR_DELIM_START—string of one or more characters (or delimiters) used to specify the start of a “phrase”
2. STR_DELIM_END—string of one or more character (or delimiters) used to specify the end of a “phrase”
3. STR_STOP_CHAR—string of one or more characters (or delimiters) used to specify processing stop (requires viewer depressing the activeKey to resume).
4. DELAY_AMOUNT—a number specifying the default delay in milliseconds.
5. aPhrases—an array that holds the “pages” to display.
6. pause_phrases—a string of one or more phrases. These phrases are written to the current page.
7. eol—a boolean specifying the “end of line” flag, set to “true” when the end of a “page” is reached (more specifically the end of an element of the “aPhrases” array).
8. isPlaying—a boolean specifying that a phrase is currently being processed, used to avoid setting multiple delays in the program when the viewer depresses the activeKey in the middle of a delay.
9. currentlndex—a number specifying the current index of the aPhrases array.
10. ActiveKey—a number specifying the keycode of the key that the viewer must press to continue program processing (for example, enter key or an arrow key).
   Methods
1. PAAT—takes a string “phrase” as entered and adds that string to the global “aPhrases” array, then increments the current index by one. The “phrase” argument may contain any mixed text, html code, delimiters, and time values (numbers).
2. write_delayed—takes a time value as entered, delays processing equivalent to that time value, then calls the write_pause_phrases method.
3. write_pause_phrases—defines which phrases to write to the “page” depending on the state of the program. First, it checks that there are elements in the aPhrases array, that the currentlndex is less than the length of the aPhrases array, and that isPlaying is “true”; if all of these conditions are met, it continues processing, otherwise it does nothing. If there is not a STR_DELIM_START in the current phrase (the element from the aPhrases array defined by the currentlndex), it writes the entire element from the aPhrases array to the “page” and passes processing on to the next element of the aPhrases array. If there is a STR_DELIM_START in the current phrase, it defines the next phrase to process by the STR_DELIM_START and the STR_DELIM_END, resets the current phrase to be the remainder of the current aPhrases element, and checks for a STR_STOP_CHAR. If a STR_STOP_CHAR exists, it stops processing by setting isPlaying to “false” (processing will not continue until the viewer hits the key defined by activeKey). If there is not a STR_STOP_CHAR, it parses out the delay time and sets the local variable “delayAmount” to that time. Then it writes the currently defined pause_phrases to the page by calling WriteLayer with pause_phrases as entered. Finally, it calls itself (write_pause_phrases) after a delay defined by the local variable “delayAmount”.
4. WriteLayer—takes a page element ID (for example “MyLayer”), a parent element ID (deprecated), and text as entered and writes the text to the given page element.
5. Key—takes a window event as enetered and calls the appropriate method depending on program state. The write_pause_phrases method will be called as long as there are more “pages” to process in the aPhrases array, isPlaying is “false”, and the key defined by activeKey was pressed. When these conditions are met, isPlaying is set to “true”.
   Process Definitions
1. Initialization. The following occurs before complete page loading:
   phrase delimiters (STR_DELIM_START and STR_DELIM_END) are defined to mark the beginning and end of phrases;
   the stop delimiter (STR_STOP_CHAR) is defined;
   the default time delay (DELAY_AMOUNT) is defined;
   the aPhrases array is initialized as an empty array;
   the pause_phrases string is initialized as an empty string;
   the eol variable is set to “false”;
   the isPlaying variable is set to “true”;
   the currentlndex is set to 0 (the start of the aPhrases array);
   the activeKey is set;
   each text element is defined and inserted into the aPhrases array and the currentlndex is incremented;
   once all text elements are added, the currentlndex is reset to 0;
   the HTML document is set to capture key press events.
2. Page Loading. When the HTML page loads, the write_gpause_phrases method is called.

Particular exemplary embodiments of the present invention have been described in detail. These exemplary embodiments are illustrative of the inventive concept recited in the appended claims, and are not limiting of the scope or spirit of the invention as contemplated by the inventor.

I claim:

1. A method of displaying a document on an electronic display device, comprising:
creating a document file, wherein the document file is a computer-readable file that includes content, wherein the content includes text;
delimiting at least a predetermined portion of the text of the document file, to define delimited content; and
displaying the document file such that the delimited content is displayed differently with respect to timing than other portions of the content of the document file.

2. The method of claim 1, wherein creating a document file does not include writing programming code.

3. The method of claim 1, wherein delimiting at least a predetermined portion of the text of the document file does not include writing programming code.

4. The method of claim 1, wherein delimiting at least the predetermined portion of the text of the document file includes adding at least one delimiter to the text of the document file such that the at least one delimiter is associated with the predetermined portion of the content of the document file, to define the delimited content.

5. The method of claim 4, wherein the at least one delimiter is at least two delimiters.

6. The method of claim 4, further comprising using a microprocessor device to read the document file with the at least one delimiter and cause the document to be displayed on the electronic display device.

7. The method of claim 1, wherein the content further includes at least one object tag.

8. The method of claim 7, wherein the at least one object tag includes at least one of formatting tags, hyperlink tags, image source tags, sound source tags, video source tags, table tags, form tags, frame tags, style tags, div tags, class tags, embed tags, object elements, JavaScript, and Java applets.

9. The method of claim 1, wherein displaying the document file includes using a computer operating program to run the document file.

10. The method of claim 9, wherein the computer operating program is a JavaScript program.

11. The method of claim 1, wherein displaying the document file includes reading the document file using a network interface.

12. The method of claim 11, wherein the network interface is a Web browser.

13. The method of claim 11, further comprising storing the document file and an operating program.

14. The method of claim 13, wherein displaying the document file includes selecting a hyperlink.

15. The method of claim 1, wherein the at least one delimiter includes a delimiter that allows at least one portion of the content to be displayed, and prevents the delimited content from being displayed automatically.

16. The method of claim 15, wherein the delimiter allows the delimited content to be displayed only after a viewer performs a predetermined function.

17. The method of claim 16, wherein the predetermined function is movement of an action key, wherein the action key is an element of an input device in communication with a microprocessor device that is in communication with the electronic display device.

18. The method of claim 17, wherein the action key is an enter key.

19. The method of claim 1, wherein the at least one delimiter includes a delimiter that allows at least one portion of the content to be displayed before a predetermined delay, and the delimited content to be displayed automatically after the predetermined delay.

20. The method of claim 19, further comprising numerically specifying the delimiter to predetermine the amount of the delay.

21. The method of claim 1, wherein the at least one delimiter includes a delimiter that allows the delimited content to be displayed in a first format before a predetermined delay, and in a second format after the predetermined delay.

22. The method of claim 21, wherein the delimited content includes delimited text.

23. The method of claim 22, wherein the first format and the second format respectively include any one or more of underlining, italicizing, bolding, coloring, highlighting, font changing, size changing, striking through, superscripting, subscripting, shadowing, outlining, embossing, engraving, capitalizing, converting to a hyperlink, hiding, spacing, and blinking applied to the delimited text.

24. The method of claim 21, further comprising numerically specifying the delimiter to predetermine the amount of the delay.

25. The method of claim 1, wherein the at least one delimiter includes a delimiter that allows the delimited content to be displayed in a first format before a viewer moves an action key, and in a second format after the viewer moves the action key, wherein the action key is an element of an input device in communication with a microprocessor device that in communication with the electronic display device.

26. The method of claim 25, wherein the action key is an enter key.

27. The method of claim 25, wherein the delimited content includes delimited text.

28. The method of claim 27, wherein the first format and the second format respectively include any one or more of underlining, italicizing, bolding, coloring, highlighting, font changing, size changing, striking through, superscripting, subscripting, shadowing, outlining, embossing, engraving, capitalizing, converting to a hyperlink, hiding, spacing, and blinking applied to the delimited text.

29. The method of claim 1, wherein the at least one delimiter includes a delimiter that allows the delimited content to be displayed before a predetermined delay and replacement content to be displayed automatically after the predetermined delay.

30. The method of claim 29, wherein the document file includes a sequence of strings.

31. The method of claim 30, further comprising advancing through the sequence of strings to display the delimited content before the predetermined delay and to display the replacement content automatically after the predetermined delay.

32. The method of claim 29, further comprising numerically specifying the delimiter to predetermine the amount of the delay.

33. The method of claim 1, wherein the at least one delimiter includes a delimiter that allows the delimited content to be displayed before a viewer moves an action key, and replacement content to be displayed after the viewer moves the action key, wherein the action key is an element of an input device in communication with a microprocessor device that in communication with the electronic display device.

34. The method of claim 33, wherein the action key is an enter key.

35. The method of claim 33, wherein the document file includes a sequence of strings.

36. The method of claim 35, further comprising advancing through the sequence of strings on movement of the action key.

37. The method of claim 36, wherein the electronic display device includes a display screen that has a viewing area, the delimited content fills the viewing area, and the replacement content replaces all of the delimited content in the viewing area.

38. The method of claim 37, further comprising replacing the content filling the viewing area with new replacement content by successive movement of the action key.

39. The method of claim 38, wherein the content is framed content, and the viewing area is at least one frame of the framed content.

40. The method of claim 1, wherein the delimited content is additional content.

41. The method of claim 40, wherein the additional content is displayed concurrently with other portions of the content.

42. The method of claim 41, wherein the electronic display device includes a display screen, and the additional content is displayed on the display screen concurrently with the other portions of the content.

43. The method of claim 40, wherein the additional content includes additional text.

44. The method of claim 43, wherein the additional text includes at least one of letters, symbols, spaces, numbers, words, sentences, paragraphs, characters, and groups of characters.

45. The method of claim 43, wherein the additional content includes annotation content.

46. The method of claim 45, wherein the at least one delimiter includes a delimiter that prevents the annotation content from being displayed before a predetermined delay and allows the annotation content to be displayed automatically after the predetermined delay.

47. The method of claim 46, further comprising numerically specifying the delimiter to predetermine the amount of the delay.

48. The method of claim 40, wherein the at least one delimiter includes a delimiter that prevents the additional content from being displayed before a predetermined delay and allows the additional content to be displayed automatically after the predetermined delay.

49. The method of claim 48, further comprising numerically specifying the delimiter to predetermine the amount of the delay.

50. The method of claim 40, wherein the at least one delimiter includes a delimiter that prevents the additional content from being displayed before a viewer moves an action key, and allows the additional content to be displayed after the viewer moves the action key, wherein the action key is an element of an input device in communication with a microprocessor device that is in communication with the electronic display device.

51. The method of claim 50, wherein the action key is an enter key.

52. The method of claim 40, wherein the at least one delimiter includes a delimiter that prevents the annotation content from being displayed before a viewer moves an action key, and allows the annotation content to be displayed after the viewer moves the action key, wherein the action key is element of an input device in communication with a microprocessor device that in communication with the electronic display device.

53. The method of claim 52, wherein the action key is an enter key.

54. The method of claim 1, wherein the document file includes at least one of text, links to still image files, moving image files, sound files, and binary files, formatting tags, forms, and hyperlinks to Web pages.

55. The method of claim 54, wherein the content includes at least one of text, still images, moving images, sounds, and Web pages.

56. The method of claim 55, wherein the delimited content includes at least one of text, symbols, numbers, geometric shapes, still images, moving images, and sounds.

57. The method of claim 56, wherein the delimited content includes delimited text.

58. The method of claim 57, wherein the delimited text includes one or more of pages of text, paragraphs of text, sentences, words, characters, and groups of characters.

59. The method of claim 1, wherein the document file is one of a plaintext file, an HTML file and an XHTML file.

60. The method of claim 1, wherein the document file includes at least one string.

61. The method of claim 60, wherein the document file includes a sequence of strings.

62. The method of claim 61, wherein at least one string of the sequence of strings is different than another string of the sequence of strings.

63. The method of claim 61, wherein at least one string of the sequence of strings is the same as another string of the sequence of strings.

64. A storage medium comprising instructions that can be implemented by a microprocessor device to cause a document to be displayed on an electronic display device, wherein the instructions include:
allowing an author to create a document file, wherein the document file is a computer-readable file that includes content, wherein the content includes text;
allowing the author to delimit at least a portion of the text of the document file, to define delimited content; and
displaying the document file such that the delimited content is displayed differently with respect to timing than other portions of the content of the document file.

65. The storage medium of claim 64, wherein the instructions further include an operating program.

66. The storage medium of claim 65, wherein the document file is embedded within the operating program.

67. The storage medium of claim 64, wherein allowing the author to delimit at least a portion of the text of the document file includes allowing the author to add delimiting text.

68. The storage medium of claim 64, wherein allowing a author to create a document file includes allowing a author to create a document file according to a standard application program.

69. The storage medium of claim 68, wherein the standard application program is a word processing program.

70. The storage medium of claim 64, wherein allowing a author to create a document file does not include requiring the author to write programming code.

71. The storage medium of claim 64, wherein allowing the author to delimit at least a portion of the text of the document file does not include requiring the author to write programming code.

72. An integrated device including the storage medium, microprocessor device, and electronic display device of claim 64.

73. The integrated device of claim 72, wherein displaying the document file such that the delimited content is displayed differently than other portions of the content of the document file includes allowing at least one portion of the content to be displayed, and preventing the delimited content from being displayed automatically.

74. The integrated device of claim 73, wherein displaying the document file such that the delimited content is displayed differently than other portions of the content of the document file further includes allowing the delimited content to be displayed only after a viewer performs a predetermined function.

75. The integrated device of claim 74, further comprising an action key in communication with the microprocessor device, wherein the predetermined function is movement of the action key.
